(19) United States
(12) Patent Application Publication
(10) Pub. No.: US 2026/0246563 A1
(43) Pub. Date: Aug. 20, 2026

(54) MUTUAL INFORMATION ESTIMATION FOR CONSTELLATION SHAPING FOR ENCODING

(71) Applicant: Lenovo (United States) Inc., Morrisville, NC (US)

(72) Inventors: Abir Ben Hadj Fredj, Wiesbaden (DE); Karthikeyan Ganesan, Kronberg Im Taunus (DE); Ali Ramadan Ali, Kraiburg (DE); Razvan-Andrei Stoica, Essen (DE)

(73) Assignee: Lenovo (United States) Inc., Morrisville, NC (US)

(21) Appl. No.: 19/054,368

(22) Filed: Feb. 14, 2025

(51) Int. Cl. H04L 1/00

(52) U.S. Cl. CPC H04L 1/0046; H04L 1/0042

(57) ABSTRACT

Various aspects of the present disclosure relate to mutual information estimation for constellation shaping for encoding. An apparatus, e.g., a user equipment (UE) or a network equipment (NE), estimates, at a transmitter, mutual information including uncertainty information associated with one or more of a received signal or a transmitted signal. The apparatus selects a modulation and coding scheme based at least in part on the estimated mutual information, and adjusts parameters of a probability mass function (PMF) of one or more probabilities of occurrences of constellation symbols based at least in part on the estimated mutual information, where the PMF is associated with the selected modulation and coding scheme. The apparatus maps information bits to the constellation symbols based at least in part on the adjusted PMF, and encodes the mapped information bits using the selected modulation and coding scheme.

### TECHNICAL FIELD

The present disclosure relates to wireless communications, and more specifically to modulation and coding in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to estimate mutual information including uncertainty information associated with one or more of a received signal or a transmitted signal; select a modulation and coding scheme based at least in part on the estimated mutual information; adjust parameters of a probability mass function (PMF) of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

A processor (e.g., a standalone processor chipset, or a component of a UE) for wireless communication is described. The processor may be configured to, capable of, or operable to perform one or more operations as described herein. For example, the processor may be configured to, capable of, or operable to estimate mutual information including uncertainty information associated with one or more of a received signal or a transmitted signal; select a modulation and coding scheme based at least in part on the estimated mutual information; adjust parameters of a PMF of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

A method performed or performable by a UE for wireless communication is described. The method may include estimating mutual information including uncertainty information associated with one or more of a received signal or a transmitted signal; selecting a modulation and coding scheme based at least in part on the estimated mutual information; adjusting parameters of a PMF of one or more probabilities of occurrences of constellation symbols based at least in part on the estimated mutual information, where the PMF is associated with the selected modulation and coding scheme; mapping information bits to the constellation symbols based at least in part on the adjusted PMF; and encoding the mapped information bits using the selected modulation and coding scheme.

In some implementations of the UE, the processor, and the method described herein, the selected modulation and coding scheme includes a code rate and a modulation order.

In some implementations of the UE, the processor, and the method described herein, the one or more probabilities of occurrences of constellation symbols follow a Gaussian distribution.

In some implementations of the UE, the processor, and the method described herein, the UE, the processor, and the method may further be configured to, capable of, operable to, performed to, or performable to determine, based at least in part on channel conditions, a probabilistic constellation shaping parameter associated with the PMF and a code rate.

In some implementations of the UE, the processor, and the method described herein, the estimated mutual information is determined in a closed loop form.

In some implementations of the UE, the processor, and the method described herein, the parameters of the PMF of constellation symbols are adjusted to maximize a shaping gain of the selected modulation and coding scheme.

In some implementations of the UE, the processor, and the method described herein, the UE, the processor, and the method may further be configured to, capable of, operable to, performed to, or performable to partition the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols.

In some implementations of the UE, the processor, and the method described herein, the first subset of constellation symbols and the second subset of constellation symbols are selected to increase a shaping gain and reduce entropy loss associated with the selected modulation and coding scheme.

In some implementations of the UE, the processor, and the method described herein, the first subset of constellation symbols includes inner constellation points of the constellation symbols, and the second subset of constellation symbols includes outer constellation points of the constellation symbols.

In some implementations of the UE, the processor, and the method described herein, the transmitter of the UE includes a distribution matcher to map the information bits to the first subset of constellation symbols and the second subset of constellation symbols.

An NE (e.g., a base station) for wireless communication is described. The NE may be configured to, capable of, or operable to perform one or more operations as described herein. For example, the NE may be configured to, capable of, or operable to estimate mutual information including uncertainty information associated with one or more of a received signal or a transmitted signal; select a modulation and coding scheme based at least in part on the estimated mutual information; adjust parameters of a PMF of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

A processor (e.g., a standalone processor chipset, or a component of a NE) for wireless communication is described. The processor may be configured to, capable of, or operable to perform one or more operations as described herein. For example, the processor may be configured to, capable of, or operable to estimate mutual information including uncertainty information associated with one or more of a received signal or a transmitted signal; select a modulation and coding scheme based at least in part on the estimated mutual information; adjust parameters of a PMF of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

A method performed or performable by an NE (e.g., a base station) for wireless communication is described. The method may include estimating mutual information including uncertainty information associated with one or more of a received signal or a transmitted signal;
selecting a modulation and coding scheme based at least in part on the estimated mutual information; adjusting parameters of a PMF of one or more probabilities of occurrences of constellation symbols based at least in part on the estimated mutual information, where the PMF is associated with the selected modulation and coding scheme; mapping information bits to the constellation symbols based at least in part on the adjusted PMF; and encoding the mapped information bits using the selected modulation and coding scheme.

In some implementations of the NE, the processor, and the method described herein, the selected modulation and coding scheme includes a code rate and a modulation order.

In some implementations of the NE, the processor, and the method described herein, the one or more probabilities of occurrences of constellation symbols follow a Gaussian distribution.

In some implementations of the NE, the processor, and the method described herein, the NE, the processor, and the method may further be configured to, capable of, operable to, performed to, or performable to determine, based at least in part on channel conditions, a probabilistic constellation shaping parameter associated with the PMF and a code rate.

In some implementations of the NE, the processor, and the method described herein, the estimated mutual information is determined in a closed loop form.

In some implementations of the NE, the processor, and the method described herein, the parameters of the PMF of constellation symbols are adjusted to maximize a shaping gain of the selected modulation and coding scheme.

In some implementations of the NE, the processor, and the method described herein, the NE, the processor, and the method may further be configured to, capable of, operable to, performed to, or performable to partition the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols.

In some implementations of the NE, the processor, and the method described herein, the first subset of constellation symbols includes inner constellation points of the constellation symbols, and the second subset of constellation symbols includes outer constellation points of the constellation symbols.

### BRIEF DESCRIPTION OF THE DRAWINGS

FIG. 1 illustrates an example of a wireless communications system in accordance with aspects of the present disclosure.

FIG. 2 illustrates an example distribution graph for probabilistic constellation shaping (PCS).

FIG. 3 illustrates an example system for PCS.

FIG. 4 illustrates an example for bits to symbols mapping and symbols distribution.

FIG. 5 illustrates an example graph showing a correlation between codeword length and PCS gain.

FIG. 6 illustrates an example PCS transceiver.

FIG. 7 illustrates a representation of conditional entropy and the mutual information.

FIG. 8 illustrates an example system in accordance with aspects of the present disclosure.

FIG. 9 illustrates an example for constellation symbols subset partitioning in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. Some wireless communication use scenarios include immersive communication, hyper-reliable and low-latency communication, ubiquitous connectivity, massive communication, artificial intelligence (AI) and communication, and integrated sensing and communication. To support these use cases, target conditions have been defined in terms of spectral efficiency, energy efficiency, latency, and reliability. To meet these target conditions, channel coding and modulation schemes may be adapted.

Channel coding and modulation schemes are fundamental building blocks in wireless communication systems. High order modulations, for example 1024-quadrature amplitude modulation (QAM) and 4096-QAM, represent techniques to increase spectral efficiency. While other techniques such as multiple user (MU) multiple input multiple output (MIMO) and single user (SU)-MIMO can be used for high spectral efficiency, such techniques may be limited in mobility scenarios and scenarios where a channel rank is limited. High order modulations serve as complementary solutions to maintain high spectral efficiencies in such scenarios. Conventional coherent transmission is based on QAM, which uses a combination of phase and amplitude to encode bits of data.

Some modulation and coding schemes use constellations (also known as constellations symbols), which involve mapping data symbols of data to be transmitted to specific points in a complex plane, known as constellation points. These constellation points represent different signal states that can be transmitted over a communication channel. In examples, each constellation point is a combination (e.g., unique combination) of phase and amplitude, with phase represented by the angle and amplitude by the distance from the center of a constellation diagram. With some modulation schemes, each constellation point has the same probability of being used for transmission. This can result in outer constellation points, with higher amplitude and therefore using more energy/power, having the same probability of being used for transmission as inner constellation points with lower energy/power. PCS can use the lower energy/power inner constellation points more frequently and the higher energy/power outer constellation points less frequently, enabling PCS to provide benefits such as enhanced granularity, improved tolerance to noise and/or nonlinearities, and rate flexibility. High shaping gains over additive white gaussian noise (AWGN) channels can be achieved when constellation symbols follow a Boltzman-Maxwell distribution.

Aspects of the present disclosure are described in the context of a wireless communications system, and include solutions which enable adaptive fine tuning of the PMF of the constellation points based on a closed loop form that provides accurate estimation of the mutual information or generalized mutual information at the transmitter. In the discussion herein, generalized mutual information may be implemented as or include generalized mutual information. The described solutions can adaptively configure the Boltzmann-Maxwell PMF parameters based on the accurate estimation of the mutual information at the transmitter. Mutual information, for example, represents the amount of information that can be transmitted via a channel, and quantifies the reduction in uncertainty about transmitted data given received data for transmission. Mutual information may also refer to a quantification of mutual dependence between transmitted data and received data. The mutual information-based adaptive configuration can include selecting a modulation and coding scheme which includes a target code rate and modulation order adapted to varying channel conditions. When the modulation and coding scheme is selected, the PMF of the constellation symbols can be adjusted/fine-tuned to maximize the harvested shaping gain and enable improved block error rate (BLER) performance and/or higher throughputs. In this discussion herein, shaping gain can refer to increases in signal strength and/or signal gain that are achievable via shaping, e.g., PCS.

The disclosure also includes procedures to adaptively partition the constellations symbols into subsets of constellation points, including a subset of constellation points that follow a selected PMF and a subset of remaining constellation points that are uniformly distributed. The subsets of constellation points can be selected based on the estimated mutual information, and can include selection of a subset of constellation points (constellation symbols) that are based on the configured PMF adapted to the time-varying channel, and a subset of constellation points (constellation symbols) that are uniformly distributed within the constellations symbols. In implementations, selection of the subsets of constellation points can balance a maximized shaping gain achieved via PCS and a reduced entropy loss and/or maximized system capacity.

By performing the described techniques, devices and wireless networks in a wireless communications system can achieve increased data transmission capabilities, spectral efficiency, energy efficiency, and reliability, while reducing data latency and inefficient use of channel resources, e.g., time-frequency resources.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

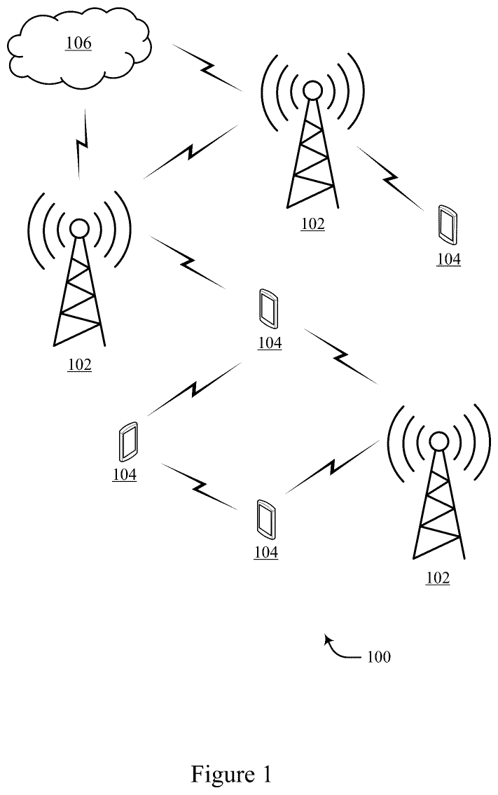

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 estimates, at a transmitter of the UE, mutual information including uncertainty information associated with one or more of a received signal or a transmitted signal. The UE 104 selects a modulation and coding scheme based at least in part on the estimated mutual information, and adjusts parameters of a PMF of one or more probabilities of occurrences of constellation symbols based at least in part on the estimated mutual information, where the PMF is associated with the selected modulation and coding scheme. The UE 104 maps information bits to the constellation symbols based at least in part on the adjusted PMF, and encode the mapped information bits using the selected modulation and coding scheme.

An NE 102 (e.g., a base station, gNB) estimates, at a transmitter of the NE, mutual information including uncertainty information associated with one or more of a received signal or a transmitted signal. The NE 102 selects a modulation and coding scheme based at least in part on the estimated mutual information, and adjusts parameters of a PMF of occurrences of constellation symbols based at least in part on the estimated mutual information, where the PMF is associated with the selected modulation and coding scheme. The NE 102 maps information bits to the constellation symbols based at least in part on the adjusted PMF, and encodes the mapped information bits using the selected modulation and coding scheme.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to modulation and coding, QAM is a family of digital modulation methods and a related family of analog modulation methods used in telecommunications to transmit information. QAM generates two analog message signals, or two digital bit streams, by changing (modulating) the amplitudes of two carrier waves, using the amplitude-shift keying (ASK) digital modulation scheme or amplitude modulation (AM) analog modulation scheme. The two carrier waves are of the same frequency and are out of phase with each other by 90°, a condition known as orthogonality or quadrature. The transmitted signal is created by adding the two carrier waves together. At the receiver, the two waves can be coherently separated (demodulated) because of their orthogonality. Another property is that the modulations are low-frequency/low-bandwidth waveforms compared to the carrier frequency, which is known as the narrowband assumption.

An encoder constellation can be used in digital communication systems, e.g., in modulation schemes, and involves mapping data symbols to specific points in a complex plane, known as constellation points. These points represent different signal states that can be transmitted over a communication channel. For example, in a QAM scheme, each constellation point corresponds to a combination (e.g., unique combination) of amplitude values and phase values. An encoder takes input data (information bits) and maps the data to constellation points, which can be modulated and transmitted as modulated signals.

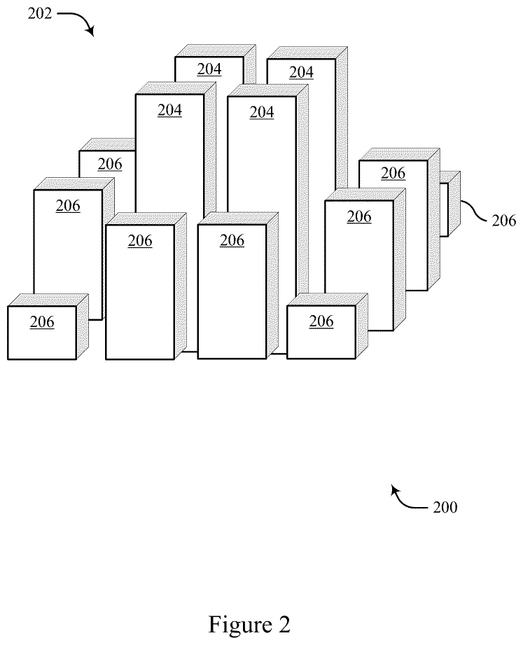

FIG. 2 illustrates an example distribution graph 200 for PCS. PCS is a technique used to enhance the efficiency of modulation and coding schemes in wireless communication systems. PCS adjusts the probability distribution of transmitted symbols to better match the channel conditions, which can lead to significant performance gains. The distribution graph 200 indicates a relative probability that constellation points will be transmitted, and includes a set of constellation points 202 of constellation symbols, with constellation points 204 representing inner constellation points, and constellation points 206 representing outer constellation points. The constellation points 204 represent lower energy/power constellation points that have a higher probability of corresponding to constellation points that are transmitted more frequently. The constellation points 206 represent higher energy/power constellation points that have less probability than the constellation points 204 of being transmitted.

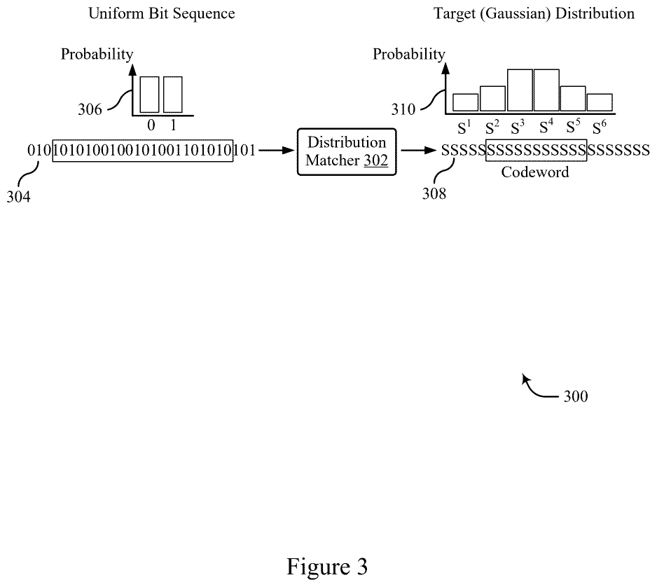

FIG. 3 illustrates an example system 300 for PCS. The system 300 includes a distribution matcher 302 that receives input of an approximately uniform information bit sequence 304 (e.g., ones and zeros with approximately equal probability). A bit probability graph 306 illustrates that each bit of the information bit sequence 304 has an approximately equal probability of being transmitted. The distribution matcher 302 converts the approximately uniform information bit sequence 304 into symbols 308 (S) with a target distribution (e.g., Gaussian distribution), as illustrated by a symbol probability graph 310. The symbols 308 can be transmitted by a transmitter, and at a receiver, a reverse distribution matcher can convert the symbols 308 back to the information bit sequence 304.

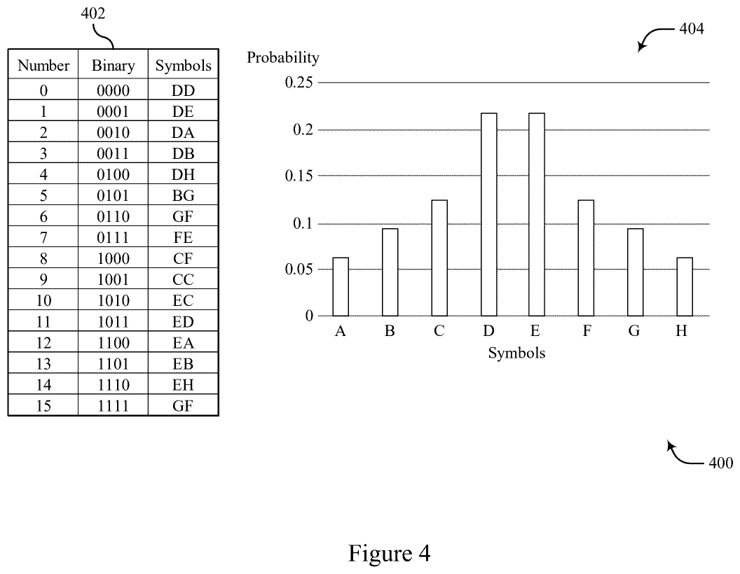

FIG. 4 illustrates an example 400 for bits to symbols mapping and symbols distribution. The example 400 describes an example operation of the distribution matcher 302. For example, take four bits (0 to 15) and convert these to two symbols from among eight possible symbols, letters A to H, as shown in a table 402. In the incoming bitstream, D symbols and E symbols are more highly probable for transmission than A symbols or H symbols, as illustrated in a symbols distribution graph 404.

In examples, information bits may not be mapped to individual symbols, and a string of information bits may be being mapped to a combination of symbols. In the example 400, 6 information bits are used (two 3-bit symbols) to transmit 4 bits worth of data, so the data rate is two-thirds of what may occur with full modulation with the symbols used equally. The distribution matcher 302 can find a bits-to-symbol mapping that meets a target data rate (effective information bits per symbol) with the specified probability distribution. The mapping can be done in real time for a changing stream of information bits. The quality of the mapping can be based on data being processed, such as based on the codeword length. For example, a long codeword increases the probability that a specified match can be determined.

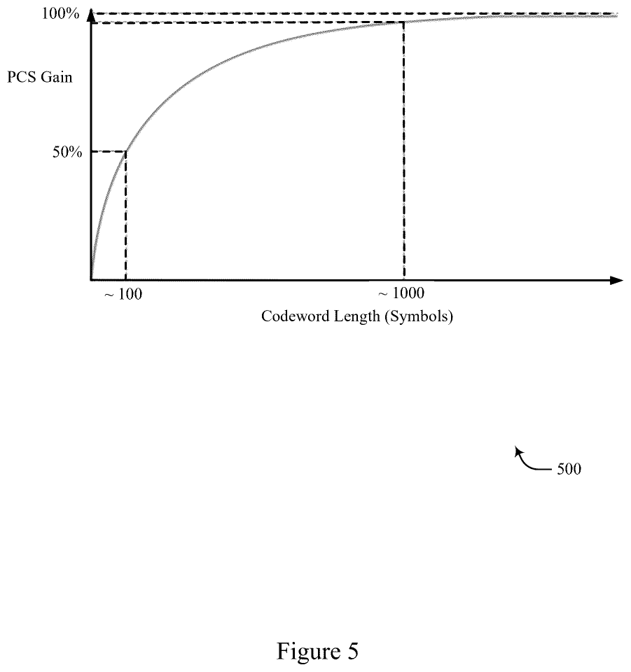

FIG. 5 illustrates an example graph 500 showing a correlation between codeword length and PCS gain. As illustrated in the graph 500, a codeword length of approximately 100 symbols results in approximately half the gain of a codeword with a length of approximately 1,000 symbols, with diminishing returns as codeword length increases beyond 1,000. A codeword with marginally more than 1,000 symbols can be enough to deliver a sufficient amount of the potential gain of PCS.

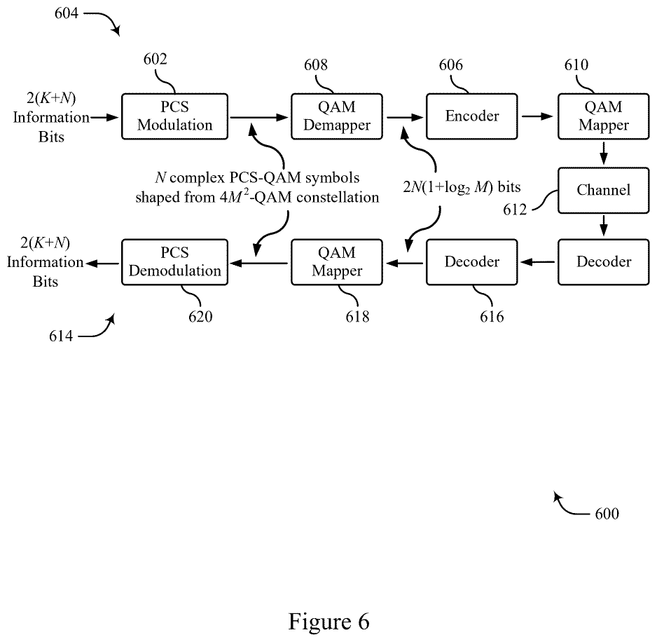

FIG. 6 illustrates an example PCS transceiver 600. The PCS transceiver 600, for example, can generate complex-valued PCS-QAM symbols that follows a Gaussian PMF. Further, the PMF can be symmetric for both positive and negative amplitudes, and real and imaginary parts of constellation symbols. In addition, the core units of the PCS transceiver 600 are a PCS modulator 602 and a PCS demodulator 620 used for PCS modulation and demodulation at a transmitter 604 and a receiver 614, respectively.

Let M≥2 be a power of 2, such that the number of bits Q carried by each symbol from 4M²-Uniform-QAM is an integer that equals:

$$Q = {log}_{2} ( 4 {M}^{2} ) = 2 ( 1 + {log}_{2} ( M ) )$$

The M amplitudes Aₘ from 2M-PAM are equal to:

$${A}_{m} = \sqrt{β} ( 2 m - 1 ) ; 1 \leq m \leq M$$

and the average power is one,

$$\frac{1}{M} {\sum }_{m = 1}^{M} {A}_{m}^{2} = 1 ,$$

where.

$$β = \frac{3}{4 {M}^{2} - 1} = \frac{3}{( {2}^{Q} - 1 )}$$

Compared to some wireless communications systems that implement uniform QAM, in the PCS transceiver 600, the PCS modulator 602 is added at the transmitter 604 prior to an encoder 606. At the PCS modulator 602, 2(K+N) information bits are split into four sequences, including two vectors of length K, and another two of length N (N≤K). The two vectors of length N are mapped by a QAM demapper 608 into sign bits. The two vectors of length K are processed by the distribution matcher, and each one is mapped into a vector of length N with entries from M positive amplitudes {A₁, A₂, . . . , A_{M}}. The two vectors with sign bits are then combined with these two vectors of positive amplitudes, and this results in two vectors of length N including symbols from a 2M-PAM modulation {−Aₘ, . . . , −A₂, −A₁, A₁, A₂, . . . Aₘ}. The PMF of the amplitudes is symmetric with p(Aₘ)=p(−Aₘ). The two real vectors are combined as the real and imaginary parts of N complex-valued symbols from a 4M²-PCS-QAM constellation.

The QAM demapper 608 transforms the N symbols into NQ bits following a conventional demapping, and these bits are then sent to the encoder 606. The PCS modulator 602 changes the transmission-probabilities of the QAM constellation, which yields a lower average power compared to uniform QAM. The encoder 606 encodes the bits and a QAM mapper 610 maps the encoded bits into symbols that can be transmitted over a channel 612. At the receiver 614, after successful decoding by a decoder 616, the decoded bits are mapped by a QAM mapper 618 back into a vector of N PCS-QAM symbols, which are further decoded by the PCS demodulator 620 into the original 2(K+N) information bits via an inverse distribution mapper operation.

A Maxwell-Boltzmann distribution can be used for PCS, which can be shown by solving the optimization p=argmax ( [symbol] −λ(E−1)) under the power constraint E≤1, with λ being the Lagrange multiplier. That is, the optimal PMF can be:

$${p}_{m} = \frac{1}{α} exp ( - \overline{v} {A}_{m}^{2} )$$

where v̅=cv; and

$$α = {\sum }_{m = 1}^{M} exp ( - \overline{v} {A}_{m}^{2} ) .$$

An optimal PCS (i.e., the parameter v̅) can be solved for optimizing theoretical rates, or practically, BLER and throughput. An observation is that the optimal PMF can also be based on the code rate c, and when c changes, v can be adjusted accordingly. Further, c also impacts the properties of power-gain, entropy-loss, and peak-to-average power ratio (PAPR). Probabilistic amplitude shaping (PAS) can be considered as c=1 due to its shaping structure. Note that with a large v̅, pₘ corresponding to large amplitudes can be zero. However, in such cases, the entropy H can also become smaller than a lower-order uniform QAM. Hence, the PCS can be applied to the lower-order constellation, and the difference can be marginal. At least for this reason, the case that p_{M}>0 of the largest amplitude A_{M} can be considered.

PCS can also involve entropy loss. The entropy with 4M²-PCS-QAM satisfies [symbol] ≤log₂(M), and the maximum can be attained with 4M²-Uniform-QAM. This can be observed by optimizing H under the constraint

$${\sum }_{m = 1}^{M} {p}_{m} = 1 .$$

This entropy loss van be caused by at least two factors. A first factor is that the average power ε_{PCS} with a Gaussian PMF is less than that with a uniform QAM due to shaping, while a second factor is that with PCS, the Gaussian distribution may be truncated and have the same support (0, \sqrt{3}) as uniform QAM when M→∞.

With the target PMF, and assuming p_{M}>0, the entropy (in bits) with PCS-QAM equals:

$$ℋ = \frac{1}{Ln ( 2 )} ( \overline{v} {ε}_{PCS} + Ln ( α ) )$$

and the maximum is attained with v̅=0. Further:

$$\frac{\partial ℋ}{\partial \overline{v}} = \frac{\overline{v}}{Ln ( 2 )} \frac{\partial {ε}_{PCS}}{\partial \overline{v}}$$

The decreasing-slope of

$$\frac{\partial ℋ}{\partial \overline{v}}$$

scales down by a factor of

$$\frac{\overline{v}}{Ln ( 2 )}$$

compared to that of ε_{PCS}.

Regarding mutual information, the mutual information between two discrete random variables X, Y jointly distributed according to p(x, y) can be given by:

$$I ( X , Y ) = {\sum }_{x , y} p ( x , y ) log ( \frac{p ( x , y )}{p ( x ) p ( y )} ) = ℋ ( X ) + ℋ ( Y ) - H ( ℋ , Y )$$

In implementations, the variable X can correspond to attributes of a transmitted signal, and the variable Y can correspond to attributes of a received signal. The mutual information between the two continuous random variables X, Y with joint probability density function ƒ(x, y) can be given by:

$$I ( X ; Y ) = \int \int f ( x , y ) log ( \frac{f ( x , y )}{f ( x ) f ( y )} ) dx dy$$

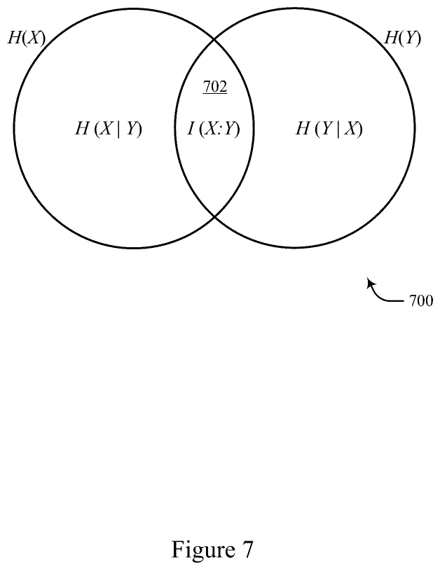

FIG. 7 illustrates a representation 700 of conditional entropy and the mutual information. For two variables, the different entropic quantities can be represented with an analogy to set theory. The representation 700 illustrates different quantities H(X) and H(Y), and mutual information 702 (I(X,Y)) is the uncertainty that is common to both X and Y.

Relative entropy is a way to measure the distance between two probability distributions, also referred to as the Kullback-Leibler divergence. The relative entropy between two probability distributions p(x) and q(x) is given by:

$$D ( p ( x ) ‖ q ( x ) ) = {\sum }_{x} p ( x ) log ( \frac{p ( x )}{q ( x )} )$$

Relative entropy is related to the mutual information 702 in the following way:

$$I ( X ; Y ) = D ( p ( x , y ) ‖ p ( x ) p ( y ) )$$

If relative entropy is a non-negative quantity, the mutual information 702 may also be non-negative.

Aspects of the present disclosure include solutions to adaptively configure the Boltzmann-Maxwell PMF parameters based on the accurate estimation of mutual information at the transmitter. Implementations include link adaption of the PMF. The PMF of constellation symbols can be adjusted to maximize the harvested shaping gain based on the estimated mutual information. Considering that a maximum harvested shaping gain when operating in optimal system conditions can be 1.53 dB, the parameters v̅ and the code rate c can be determined based on channel conditions and in order to maximize the mutual information. The Maxwell-Boltzmann distribution can be used for shaping, which can be shown by solving the optimization p=argmax( [symbol] −λ(E−1)) under the power constraint E≤1, with λ being the Lagrange multiplier. That is, an optimal PMF can be:

$${p}_{m} = \frac{1}{α} exp ( - \overline{v} {A}_{m}^{2} )$$

$$where$$

$$\overline{v} = cv ; and α = {\sum }_{m = 1}^{M} exp ( - \overline{v} {A}_{m}^{2} ) .$$

A target PCS (e.g., the parameter v) can be solved for optimizing theoretical rates or for BLER and throughput. In an example, for time-varying channel conditions, the modulation and coding scheme and corresponding value of v̅ can be determined such that the PMF pₘ maximizes the mutual information at each period T, which can maximize the system throughput, theoretical data rates, and BLER performance. In this case, the mutual information can be defined as follows:

$$I ( X ; Y ) = ℋ ( X ) + ℋ ( Y ) - ℋ ( X , Y )$$

Generalized mutual information can be defined as follows:

$$I ( X ; Y ) = I ( Y ; X ) = H ( X ) - H ( X \vert Y ) = H ( Y ) - H ( Y \vert X )$$

In implementations, generalized mutual information may represent an extension of mutual information to accommodate more complex structures, such as non-linear relationships or dependencies beyond pairwise interactions. Generalized mutual information incorporates alternative methods or metrics to compute mutual information, which may be tailored for continuous or high-dimensional spaces where mutual information may not be as effective or easily calculated.

In implementations, in time-varying channel conditions, the modulation and coding scheme and corresponding value of v can be determined and the PMF adapted to improve the BLER by increasing the harvested shaping gain. In such scenarios, the values of the parameters of the PMF can be adjusted for an average constellation power under constraints of estimated mutual information. A small value of v can cause a high entropy, and thus increased mutual information which reaches its maximum value when v̅=0. A small value of v̅ can also impact the average power and harvested power gain and shaping gain. In this regard, v̅ and the code rate c can be determined according to the channel conditions and targeted key performance indicators (KPIs) associated with a use case. In cases where low throughputs can be tolerated and conditions are put on energy and power-gain, the value of v̅ can be adjusted accordingly and considering current channel conditions. In other cases, v̅ can be determined such that the resulting PMF enables a balance between throughput or entropy loss and power gain.

In implementations, the values of the mutual information and the parameters v and c can be determined heuristically and tabulated in a look-up table and based on the channel conditions and signal-to-noise ratio (SNR) and signal-to-interference-noise ratio (SINR) values. The PMF, for example, can be adjusted in a link adaptive manner. In examples, the PMF parameter values can be determined on-the-fly and configured by NE.

In implementations, mutual information can be estimated based on a closed-loop network implementation where the receiver feeds back information to the transmitter about the received signal, the SINR, channel quality index (CQI), and other parameters that enable the transmitter to estimate the mutual information. In examples, neural networks (NN) at one or more of transmitters and receivers can be used to enable accurate estimates of the mutual information.

In implementations, the PMF pₘ can be optimized by reducing the Kullback-Leibler divergence between the actual pₘ and targeted PMF qₘ, which can enable target shaping gains and/or throughput for the given channel conditions and the targeted mutual information. In this case, the following algorithm can determine the parameters values (v̅, c) of the optimal PMF that minimize the distance:

$${D}_{KL} ( p \vert q ) = {\sum }_{m = 1}^{M} {p}_{m} Ln ( \frac{{p}_{m}}{{q}_{m}} ) .$$

In this case, the target qₘ can be determined theoretically and considering optimal and capacity-achieving system conditions. The values of qₘ associated with different mutual information, SNR, and CQI values can be determined offline and tabulated in look-up tables.

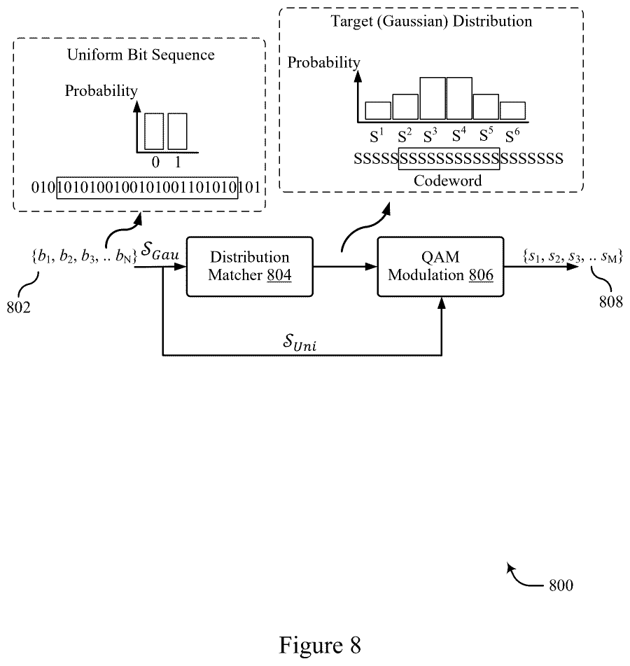

FIG. 8 illustrates an example system 800 in accordance with aspects of the present disclosure. The system 800, for example, illustrates implementations that enable constellation shaping based on subsets of symbols. As illustrated in the system 800, approximately uniform information bits 802 can be converted into a set of QAM constellation symbols [symbol] . The set of QAM constellation symbols can be divided in two subsets, where a distribution matcher 804 generates a first subset of constellation symbols [symbol] _{Gau} that follows a Boltzmann-Maxwell distribution, and the second subset of constellation symbols [symbol] _{Uni} remains approximately uniformly distributed. The first and second subsets of constellation symbols can undergo QAM modulation 806 into symbols 808 (S), which can be transmitted. The selection of the subsets [symbol] _{Gau}, [symbol] _{Uni} enables a tradeoff between the harvested shaping gain and the system capacity. In this case, a constant composition distribution matcher (CCDM) could be implemented to accommodate different distributions and map the incoming information bits 802 to symbols according to different distributions (PMFs). In the system 800, the incoming information bits 802 (b) can be divided into two parallel subsets, where the first subset [symbol] _{Gau} undergoes a CCDM and the second subset [symbol] _{Uni} is directly mapped to uniformly distributed QAM symbols 808 s.

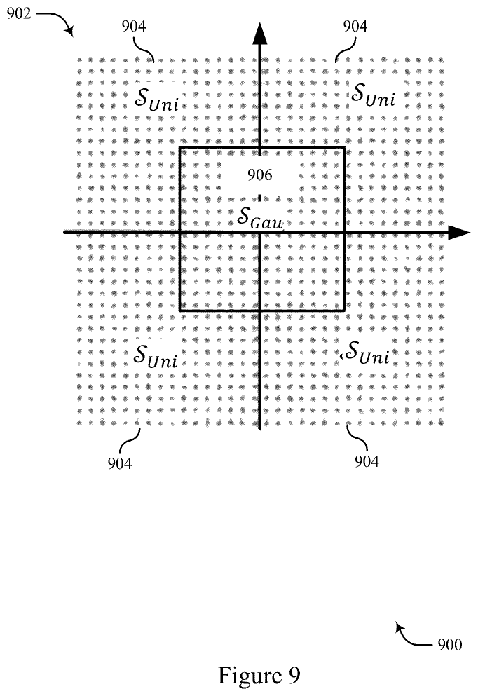

FIG. 9 illustrates an example 900 for constellation symbols subset partitioning in accordance with aspects of the present disclosure. The example 900 includes constellation symbols 902 with a constellation symbols subset 904 ( [symbol] _{Uni}) and a constellation symbols subset 906 ( [symbol] _{Gau}). In implementations, the selection of the subsets 904, 906 ( [symbol] _{Uni}, [symbol] _{Gau}) can be performed in order to reduce the entropy-loss and thus increase the system throughput by assigning a subset of the incoming information bits [symbol] _{Uni} to uniformly distributed symbols, and another subset of the incoming information bits [symbol] _{Gau} to a shaped subset of symbols distributed according to a PMF such that the signaling is Gaussian. In examples, the distribution of the inner constellation points (constellation symbols subset 906) can be configured as a Gaussian distribution, and the distribution of the outer constellation points (constellation symbols subset 904) can be configured as an approximately uniform distribution, as illustrated in the example 900.

In such scenarios where constellations symbols are partitioned into subsets, the symbols around the center of the constellation (constellation symbols subset 906) can have the highest probabilities of occurrence, which can increase the average power of the distribution compared with a uniform conventional distribution. Compared with a constellation where the symbols follow a Gaussian distribution, the average power of the constellation can be reduced. The average power of the constellation can increase with the shaping gain and a high average power can increase the source entropy and can reduce the system throughput. Fine tuning the average power to reach a capacity-shaping gain tradeoff can be performed by partitioning the constellation into the two constellation symbols subsets 904, 906 ( [symbol] _{Uni}, [symbol] _{Gau}).

In implementations, each constellation symbols subset 904, 906 can include a combination of inner constellation points and outer constellation points, where the number of outer and inner constellation points in each constellation symbols subset 904, 906 and the total number of constellation points per constellation symbols subset 904, 906 can be selected according to the best average power value that enables a balance between capacity and shaping gain for a fixed BLER value. In examples, the constellation points subset selection can be performed in a semi-static manner and can be linked to a use case, e.g., a particular application and targeted KPIs. In examples, the constellation points subset selection can be adapted to channel conditions and adjusted based on estimated parameters related to CSI and mutual information.

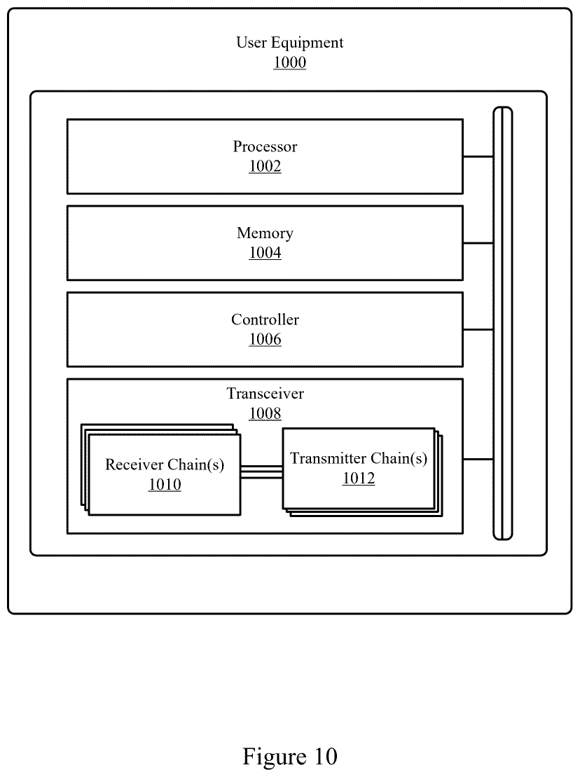

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for estimating (e.g., at a transmitter of the UE) mutual information including uncertainty information associated with one or more of a received signal or a transmitted signal; selecting a modulation and coding scheme based at least in part on the estimated mutual information; adjusting parameters of a PMF of one or more probabilities of occurrences of constellation symbols based at least in part on the estimated mutual information, where the PMF is associated with the selected modulation and coding scheme; mapping information bits to the constellation symbols based at least in part on the adjusted PMF; and encoding the mapped information bits using the selected modulation and coding scheme.

Additionally, the UE 1000 may be configured to support any one or combination of where the selected modulation and coding scheme includes a code rate and a modulation order; the one or more probabilities of occurrences of constellation symbols follow a Gaussian distribution; determining, based at least in part on channel conditions, a probabilistic constellation shaping parameter associated with the PMF and a code rate; the estimated mutual information is determined in a closed loop form; the parameters of the PMF of constellation symbols are adjusted to maximize a shaping gain of the selected modulation and coding scheme; partitioning the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols; the first subset of constellation symbols and the second subset of constellation symbols are selected to increase a shaping gain and reduce entropy loss associated with the selected modulation and coding scheme; the first subset of constellation symbols includes inner constellation points of the constellation symbols, and the second subset of constellation symbols includes outer constellation points of the constellation symbols; the transmitter of the UE includes a distribution matcher to map the information bits to the first subset of constellation symbols and the second subset of constellation symbols; further including transmitting the encoded mapped information bits.

Additionally, or alternatively, the UE 1000 may support at least one memory (e.g., the memory 1004) and at least one processor (e.g., the processor 1002) coupled with the at least one memory and configured to cause the UE to estimate (e.g., at a transmitter of the UE) mutual information including uncertainty information associated with one or more of a received signal or a transmitted signal; select a modulation and coding scheme based at least in part on the estimated mutual information; adjust parameters of a PMF of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

Additionally, the UE 1000 may be configured to support any one or combination of where the selected modulation and coding scheme includes a code rate and a modulation order; the one or more probabilities of occurrences of constellation symbols follow a Gaussian distribution; the at least one processor is operable to cause the UE to determine, based at least in part on channel conditions, a probabilistic constellation shaping parameter associated with the PMF and a code rate; the estimated mutual information is determined in a closed loop form; the parameters of the PMF of constellation symbols are adjusted to maximize a shaping gain of the selected modulation and coding scheme; the at least one processor is operable to cause the UE to: partition the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols; the first subset of constellation symbols and the second subset of constellation symbols are selected to increase a shaping gain and reduce entropy loss associated with the selected modulation and coding scheme; the first subset of constellation symbols includes inner constellation points of the constellation symbols, and the second subset of constellation symbols includes outer constellation points of the constellation symbols; the transmitter of the UE includes a distribution matcher to map the information bits to the first subset of constellation symbols and the second subset of constellation symbols; transmit the encoded mapped information bits.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

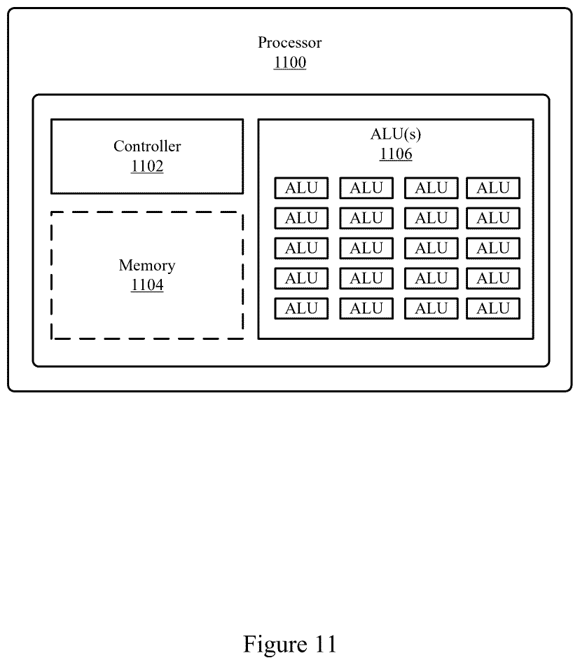

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to estimate mutual information including uncertainty information associated with one or more of a received signal or a transmitted signal; select a modulation and coding scheme based at least in part on the estimated mutual information; adjust parameters of a PMF of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

Additionally, the processor 1100 may be configured to or operable to support any one or combination of where the selected modulation and coding scheme includes a code rate and a modulation order; the one or more probabilities of occurrences of constellation symbols follow a Gaussian distribution; the at least one controller is operable to cause the processor to determine, based at least in part on channel conditions, a probabilistic constellation shaping parameter associated with the PMF and a code rate; the estimated mutual information is determined in a closed loop form; the parameters of the PMF of constellation symbols are adjusted to maximize a shaping gain of the selected modulation and coding scheme; the at least one controller is operable to cause the processor to: partition the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols; the first subset of constellation symbols and the second subset of constellation symbols are selected to increase a shaping gain and reduce entropy loss associated with the selected modulation and coding scheme; the first subset of constellation symbols includes inner constellation points of the constellation symbols, and the second subset of constellation symbols includes outer constellation points of the constellation symbols; the transmitter of the UE includes a distribution matcher to map the information bits to the first subset of constellation symbols and the second subset of constellation symbols; transmit the encoded mapped information bits.

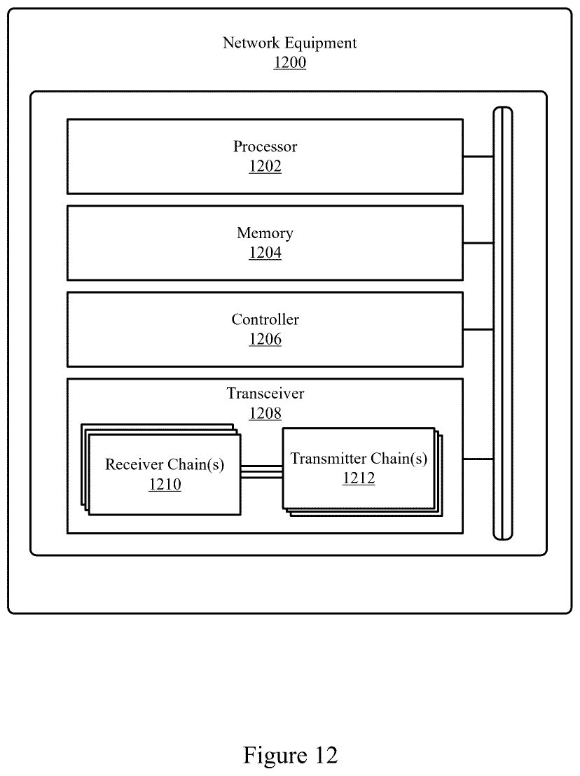

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for estimating (e.g., at a transmitter of the NE) mutual information including uncertainty information associated with one or more of a received signal or a transmitted signal; selecting a modulation and coding scheme based at least in part on the estimated mutual information; adjusting parameters of a PMF of one or more probabilities of occurrences of constellation symbols based at least in part on the estimated mutual information, where the PMF is associated with the selected modulation and coding scheme; mapping information bits to the constellation symbols based at least in part on the adjusted PMF; and encoding the mapped information bits using the selected modulation and coding scheme.

Additionally, the NE 1200 may be configured to or operable to support any one or combination of where the selected modulation and coding scheme includes a code rate and a modulation order; the one or more probabilities of occurrences of constellation symbols follow a Gaussian distribution; determining, based at least in part on channel conditions, a probabilistic constellation shaping parameter associated with the PMF and a code rate; the estimated mutual information is determined in a closed loop form; the parameters of the PMF of constellation symbols are adjusted to maximize a shaping gain of the selected modulation and coding scheme; partitioning the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols; the first subset of constellation symbols and the second subset of constellation symbols are selected to increase a shaping gain and reduce entropy loss associated with the selected modulation and coding scheme; the first subset of constellation symbols includes inner constellation points of the constellation symbols, and the second subset of constellation symbols includes outer constellation points of the constellation symbols; the transmitter of the NE includes a distribution matcher to map the information bits to the first subset of constellation symbols and the second subset of constellation symbols; further including transmitting the encoded mapped information bits.

Additionally, or alternatively, the NE 1200 may support at least one memory (e.g., the memory 1204) and at least one processor (e.g., the processor 1202) coupled with the at least one memory and configured to cause the NE to estimate (e.g., at a transmitter of the NE) mutual information including uncertainty information associated with one or more of a received signal or a transmitted signal; select a modulation and coding scheme based at least in part on the estimated mutual information; adjust parameters of a PMF of one or more probabilities of occurrences of constellation symbols based at least in part on the estimated mutual information, where the PMF is associated with the selected modulation and coding scheme; map information bits to the constellation symbols based at least in part on the adjusted PMF; and encode the mapped information bits using the selected modulation and coding scheme.

Additionally, the NE 1200 may be configured to support any one or combination of where the selected modulation and coding scheme includes a code rate and a modulation order; the one or more probabilities of occurrences of constellation symbols follow a Gaussian distribution; the at least one processor is operable to cause the NE to determine, based at least in part on channel conditions, a probabilistic constellation shaping parameter associated with the PMF and a code rate; the estimated mutual information is determined in a closed loop form; the parameters of the PMF of constellation symbols are adjusted to maximize a shaping gain of the selected modulation and coding scheme; the at least one processor is operable to cause the NE to: partition the constellation symbols into two subsets, where a first subset of constellation symbols is configured according to the adjusted PMF, and a second subset of constellation symbols is uniformly distributed, where the information bits are mapped to the constellation symbols based at least in part on the first subset of constellation symbols and the second subset of constellation symbols; the first subset of constellation symbols and the second subset of constellation symbols are selected to increase a shaping gain and reduce entropy loss associated with the selected modulation and coding scheme; the first subset of constellation symbols includes inner constellation points of the constellation symbols, and the second subset of constellation symbols includes outer constellation points of the constellation symbols; the transmitter of the NE includes a distribution matcher to map the information bits to the first subset of constellation symbols and the second subset of constellation symbols; transmit the encoded mapped information bits.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or QAM. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

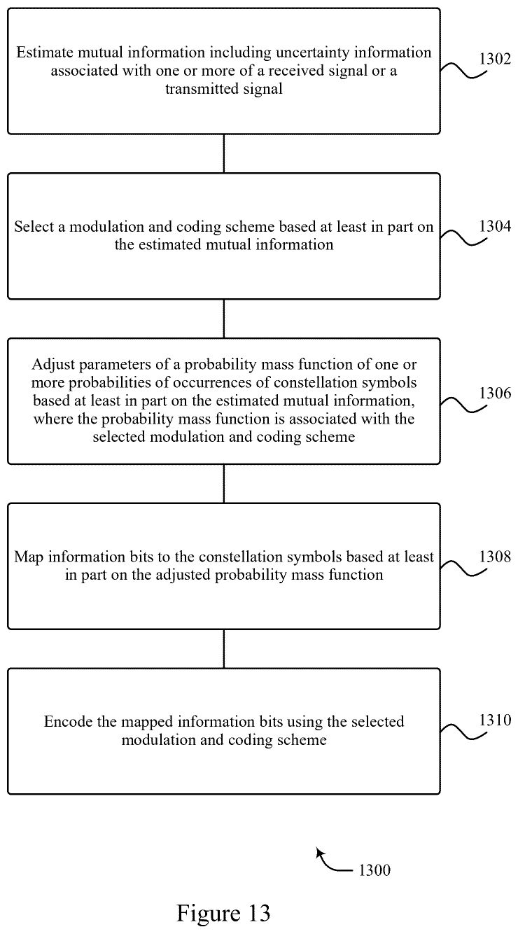

FIG. 13 illustrates a flowchart of a method 1300 in accordance with aspects of the present disclosure. The operations of the method may be implemented by a UE and/or an NE as described herein. In some implementations, the UE and/or the NE may execute a set of instructions to control the function elements of the UE and/or the NE to perform the described functions. It should be noted that the method described herein describes a possible implementation, and that the operations and the steps may be rearranged or otherwise modified and that other implementations are possible.

At 1302, the method may include estimating mutual information including uncertainty information associated with one or more of a received signal or a transmitted signal. The operations of 1302 may be performed in accordance with examples as described herein. In some implementations, aspects of the operations of 1302 may be performed by a UE as described with reference to FIG. 10 and/or an NE as described with reference to FIG. 12.

At 1304, the method may include selecting a modulation and coding scheme based at least in part on the estimated mutual information. The operations of 1304 may be performed in accordance with examples as described herein. In some implementations, aspects of the operations of 1304 may be performed by a UE as described with reference to FIG. 10 and/or an NE as described with reference to FIG. 12.

At 1306, the method may include adjusting parameters of a PMF of one or more probabilities of occurrences of constellation symbols based at least in part on the estimated mutual information, where the PMF is associated with the selected modulation and coding scheme. The operations of 1306 may be performed in accordance with examples as described herein. In some implementations, aspects of the operations of 1306 may be performed a UE as described with reference to FIG. 10 and/or an NE as described with reference to FIG. 12.

At 1308, the method may include mapping information bits to the constellation symbols based at least in part on the adjusted PMF. The operations of 1308 may be performed in accordance with examples as described herein. In some implementations, aspects of the operations of 1308 may be performed a UE as described with reference to FIG. 10 and/or an NE as described with reference to FIG. 12.

At 1310, the method may include encoding the mapped information bits using the selected modulation and coding scheme. The operations of 1310 may be performed in accordance with examples as described herein. In some implementations, aspects of the operations of 1310 may be performed a UE as described with reference to FIG. 10 and/or an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
estimate mutual information comprising uncertainty information associated with one or more of a received signal or a transmitted signal;
select a modulation and coding scheme based at least in part on the estimated mutual information;
adjust parameters of a probability mass function of one or more probabilities of occurrences of constellation symbols based at least in part on the estimated mutual information, wherein the probability mass function is associated with the selected modulation and coding scheme;
map information bits to the constellation symbols based at least in part on the adjusted probability mass function; and
encode the mapped information bits using the selected modulation and coding scheme.

2. The UE of claim 1, wherein the selected modulation and coding scheme comprises a code rate and a modulation order.

3. The UE of claim 1, wherein the one or more probabilities of occurrences of constellation symbols follow a Gaussian distribution.

4. The UE of claim 1, wherein the at least one processor is operable to cause the UE to determine, based at least in part on channel conditions, a probabilistic constellation shaping parameter associated with the probability mass function and a code rate.

5. The UE of claim 1, wherein the estimated mutual information is determined in a closed loop form.

6. The UE of claim 1, wherein the parameters of the probability mass function of constellation symbols are adjusted to maximize a shaping gain of the selected modulation and coding scheme.

7. The UE of claim 1, wherein the at least one processor is operable to cause the UE to:
partition the constellation symbols into two subsets, wherein a first subset of constellation symbols is configured according to the adjusted probability mass function, and a second subset of constellation symbols is uniformly distributed, wherein the information bits are mapped to the constellation symbols based at least in part on the first subset of constellation symbols and the second subset of constellation symbols.

8. The UE of claim 7, wherein the first subset of constellation symbols and the second subset of constellation symbols are selected to increase a shaping gain and reduce entropy loss associated with the selected modulation and coding scheme.

9. The UE of claim 7, wherein the first subset of constellation symbols comprises inner constellation points of the constellation symbols, and the second subset of constellation symbols comprises outer constellation points of the constellation symbols.

10. The UE of claim 7, wherein the UE comprises a distribution matcher to map the information bits to the first subset of constellation symbols and the second subset of constellation symbols.

11. A network equipment (NE) for wireless communication, comprising:
at least one memory; and
at least one processor coupled with the at least one memory and operable to cause the NE to:
estimate mutual information comprising uncertainty information associated with one or more of a received signal or a transmitted signal;
select a modulation and coding scheme based at least in part on the estimated mutual information;
adjust parameters of a probability mass function of one or more probabilities of occurrences of constellation symbols based at least in part on the estimated mutual information, wherein the probability mass function is associated with the selected modulation and coding scheme;
map information bits to the constellation symbols based at least in part on the adjusted probability mass function; and
encode the mapped information bits using the selected modulation and coding scheme.

12. The NE of claim 11, wherein the selected modulation and coding scheme comprises a code rate and a modulation order.

13. The NE of claim 11, wherein the one or more probabilities of occurrences of constellation symbols follow a Gaussian distribution.

14. The NE of claim 11, wherein the at least one processor is operable to cause the NE to determine, based at least in part on channel conditions, a probabilistic constellation shaping parameter associated with the probability mass function and a code rate.

15. The NE of claim 11, wherein the estimated mutual information is determined in a closed loop form.

16. The NE of claim 11, wherein the parameters of the probability mass function of constellation symbols are adjusted to maximize a shaping gain of the selected modulation and coding scheme.

17. The NE of claim 11, wherein the at least one processor is operable to cause the NE to:
partition the constellation symbols into two subsets, wherein a first subset of constellation symbols is configured according to the adjusted probability mass function, and a second subset of constellation symbols is uniformly distributed, wherein the information bits are mapped to the constellation symbols based at least in part on the first subset of constellation symbols and the second subset of constellation symbols.

18. The NE of claim 17, wherein the first subset of constellation symbols comprises inner constellation points of the constellation symbols, and the second subset of constellation symbols comprises outer constellation points of the constellation symbols.

19. A processor for wireless communication, comprising:
at least one controller coupled with at least one memory and operable to cause the processor to:
estimate mutual information comprising uncertainty information associated with one or more of a received signal or a transmitted signal;
select a modulation and coding scheme based at least in part on the mutual information;
adjust parameters of a probability mass function of one or more probabilities of occurrences of constellation symbols based at least in part on the estimated mutual information, wherein the probability mass function is associated with the selected modulation and coding scheme;
map information bits to the constellation symbols based at least in part on the adjusted probability mass function; and
encode the mapped information bits using the selected modulation and coding scheme.

20. A method performed by an apparatus, the method comprising:
estimating mutual information comprising uncertainty information associated with one or more of a received signal or a transmitted signal;
selecting a modulation and coding scheme based at least in part on the mutual information;
adjusting parameters of a probability mass function of one or more probabilities of occurrences of constellation symbols based at least in part on the estimated mutual information wherein the probability mass function is associated with the selected modulation and coding scheme;
mapping information bits to the constellation symbols based at least in part on the adjusted probability mass function; and
encoding the mapped information bits using the selected modulation and coding scheme.
